(19) United States
(12) Patent Application Publication
(10) Pub. No.: US 2005/0219259 A1
(43) Pub. Date: Oct. 6, 2005

(54) Color correction of images while maintaining constant luminance

(76) Inventors: Robert Gonsalves, Wellesley, MA (US); Marc C. Norvig, Melrose, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 10/817,216

(22) Filed: Apr. 2, 2004

(51) Int. Cl. G09G 5/02

(52) U.S. Cl. 345/593

(57) ABSTRACT

To provide for more natural color matching and color correction, the ratio of the luminance of a pixel before correction to the luminance of the pixel after correction is computed. This ratio is used to scale the saturation of the corrected pixel, without changing its hue. For example, if the pixel is represented by a luminance component and two chrominance components, both of the chrominance components of the corrected pixel are scaled by the ratio. As a result, if the input luminance is lower than the luminance of the corrected pixel, then the saturation of the corrected pixel is reduced. If the input luminance is higher than the luminance of the corrected pixel, then the saturation of the corrected pixel is increased. The input luminance and scaled saturation of the corrected pixel are used to provide the components of an output pixel. As a result, the output pixel has the desired hue with a natural luminance and saturation.

### BACKGROUND

A common color correction operation in motion pictures involves changing the color of an object in one image to match the color of an object in another image. This operation often is called color matching. For example, color matching may be performed by adjusting red, green and blue curves (called RGB curves) that each map input red, green and blue values to output red, green and blue values. Although color matching and other color correction operations should result in the correct hue for the object in the corrected image, such operations also may change the luminance or saturation in the corrected image in a way that may look unnatural. Performing color matching of objects using RGB curves also may add a color cast to other parts of the image that are different from the object. Some editors also may find RGB curves difficult to use because manipulation of a curve not only modifies the hue of many pixels, but also affects the saturation and luminance of the pixels.

### SUMMARY

To provide for more natural color matching and color correction, the ratio of the luminance of a pixel before correction to the luminance of the pixel after correction is computed. This ratio is used to scale the saturation of the corrected pixel, without changing its hue. For example, if the pixel is represented by a luminance component and two chrominance components, both of the chrominance components of the corrected pixel are scaled by the ratio. As a result, if the input luminance is lower than the luminance of the corrected pixel, then the saturation of the corrected pixel is reduced. If the input luminance is higher than the luminance of the corrected pixel, then the saturation of the corrected pixel is increased. The input luminance and scaled saturation of the corrected pixel are used to provide the components of an output pixel. As a result, the output pixel has the desired hue with a natural luminance and saturation.

For example, an image may have pixels represented by luminance and chrominance components. Color correction operations may be defined to be performed on red, green and blue components. In this case, the luminance of the pixel before correction is stored. The pixel then is converted to a red, green and blue component representation. After color correction, the components of the corrected pixel are converted from red, green and blue components to luminance and chrominance components. The original luminance and the luminance of the corrected pixel are used to compute the scaling ratio, which is then applied to the chrominance components of the converted, corrected pixel. The original luminance and the scaled chrominance components of the converted, corrected pixel are then output as the corrected pixel. If an alpha channel is provided with an image, and if color correction is performed in hardware, a delay may be introduced in the alpha channel to accommodate for the scaling of the chrominance components.

Accordingly, in one aspect, a method, apparatus or computer program product for performing color correction on an image involves storing an input luminance value corresponding to a luminance of the pixel before color correction. A color correction operation is performed on the pixel to provide color corrected components for the pixel. An output luminance and output saturation corresponding to the color corrected components for the pixel is determined. A scaling factor is computed according to a ratio of the input luminance to the output luminance. The output saturation is scaled by the scaling factor to provide a corrected saturation. The input luminance and the corrected saturation are used to provide values for the corrected pixel.

### BRIEF DESCRIPTION OF THE DRAWINGS

In the drawings,

FIG. 1 is a data flow diagram of a system that performs constant luminance color correction.

FIG. 2 is a flow chart describing how constant luminance color correction may be performed.

### DETAILED DESCRIPTION

A nonlinear editing system allows sequences of segments of video, audio and other data stored on a random access computer readable medium to be combined into a temporal presentation. A nonlinear editing system generally has a color representation in which video data is formatted for processing. The color representation may be, for example, red, green and blue components or luminance and chrominance components, for each pixel in the video data. Each component value generally is represented by a number of bits, such as 8 bits or 10 bits. A nonlinear editing system may permit an editor to apply a color modification to a segment of video or a single image (typically called primary color correction) or a part of an image or portions of each image in a segment (typically called secondary color correction). In secondary color correction, a part of an image may be defined spatially (in the image) or in a color space (by identifying all pixels having a color close to a specified color) or both. Color modifications typically involve mathematical manipulations of the pixel values, for example, through matrix multiplication operations or lookup tables. Pixel values also often are converted from representations in one color space to another color space to apply these operations. A typical color correction operation includes color matching, through which the input pixel is modified to match at least a hue of a target color. The constant luminance color correction described below is particularly suited for use in such a nonlinear editing system, and particularly in combination with color correction operations such as color matching. Using constant luminance color correction in combination with RGB curves also makes the use of the RGB curves more intuitive.

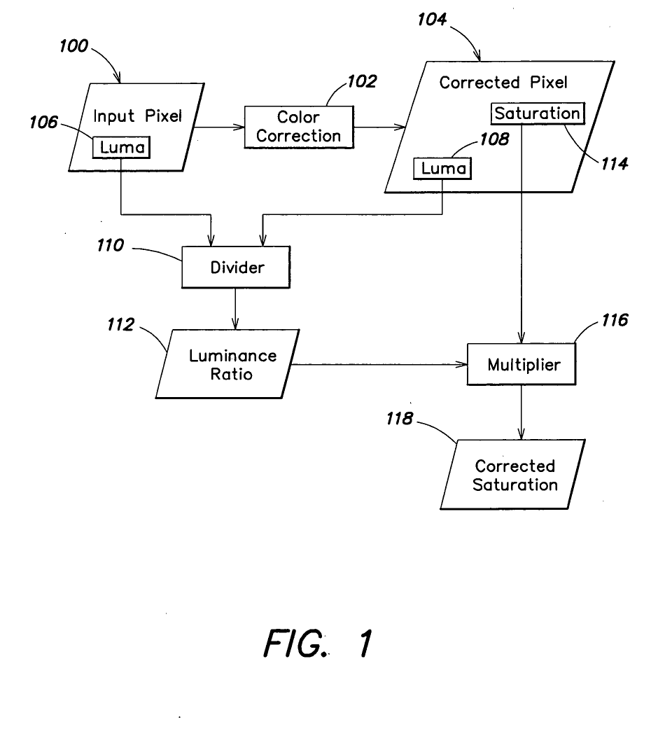

FIG. 1 is a data flow diagram of a system that performs constant luminance color correction. An input pixel 100 is applied to an input of a color corrector 102. The color corrector 102 has an output that provides a color corrected pixel 104. The color corrector 102 may perform any of a variety of color modifications to a pixel. For example, a color matching operation may be performed. The color modification may be defined, for example, using RGB curves, color wheels, level histograms or other conventional user interface techniques for color correction. The luminance 106 of the input pixel 100 and the luminance 108 of the color corrected pixel 104 are applied to the inputs of a divider 110 so as to compute the ratio 112 of the input luminance to the color corrected luminance, which is provided by the output of the divider 110. Either luminance 106 or 108 may be derived from the components used to represent the pixel. For example, either the input pixel or the corrected pixel or both may be represented by red, blue and green (RGB) components, or other format, which may be converted to YUV or YCrCb components, or other format. The saturation 114 of the color corrected pixel 104 is scaled by this ratio 112, by applying the saturation and ratio to inputs of a multiplier 116. An output of the multiplier 116 provides the corrected saturation 118. As an example, the saturation may be defined by chroma difference signals, Cr and Cb, which are multiplied by the luminance ratio. The result is that if the input luminance is lower than the calculated luminance of the corrected pixel, then the saturation of the corrected pixel is reduced. If the input luminance is greater than the calculated luminance of the corrected pixel, then the saturation of the corrected pixel is increased. Because both chrominance components of the corrected pixel are scaled equally, only the saturation, but not the hue, of the corrected pixel is changed.

This capability could be made a user-selectable option through a user interface. If implemented in software, a variable may be set that designates whether constant luminance color correction should be performed. If implemented in hardware, a multiplexer may be provided to select the output luminance as either the original input luminance or the corrected luminance. The divider also may be set to output a one (1) if constant luminance color correction is not enabled so that the saturation is not changed.

As an example, the input pixel 100 may be represented by luminance and chrominance components. Color correction operations performed by the color corrector 102 may be defined to be performed on red, green and blue components. In this case, the input pixel 100 is converted to a red, green and blue component representation for color correction. The luminance of the input pixel 100 before correction is stored. After color correction, the components of the corrected pixel 104 are converted from red, green and blue components to luminance and chrominance components to provide the luminance 108 and saturation 114. The original luminance and the luminance of the corrected pixel are used to compute the scaling ratio, which is then applied to the chrominance components of the converted, corrected pixel. The original luminance and the scaled chrominance components of the converted, corrected pixel are then output as the corrected pixel. If an alpha channel is provided with an image, and if color correction is performed in hardware, a delay may be introduced in the alpha channel to accommodate for the delay introduced by scaling the chrominance components.

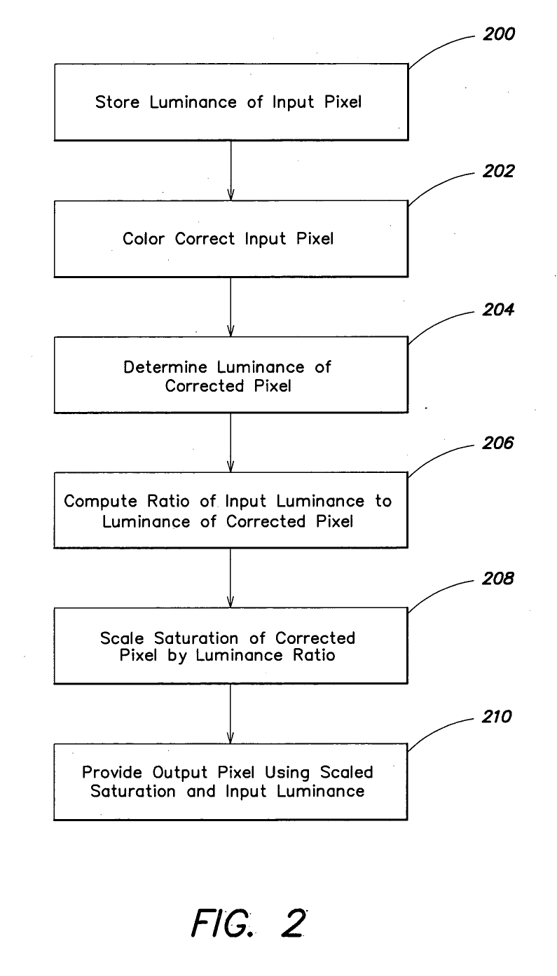

FIG. 2 is a flow chart describing how constant luminance color correction may be performed. This flowchart represents, for example, how a computer program might operate to implement constant luminance color correction on an image. For each pixel, the luminance of the input pixel is stored (200). The input pixel is color corrected (202). The luminance of the color corrected pixel is determined (204). The ratio between the luminance of the input pixel and the luminance of the color corrected pixel is computed (206). The saturation of the color corrected pixel, for example, as represented by chroma difference values Cr and Cb, is scaled (208) by the computed ratio. The scaled saturation and the input luminance are used to provide the corrected pixel. For example, the original luminance and scaled chroma difference values may be used to represent the corrected pixel.

It should be understood that the operation of scaling saturation by the luminance ratio may be performed in any color space and the invention is not limited to operation in the YCrCb color space.

A system such as described herein may be implemented in software or hardware or firmware, or a combination of the three. The various elements of the system, either individually or in combination may be implemented as one or more computer program products in which computer program instructions are stored on a computer readable medium for execution by a computer. Various steps of a process may be performed by a computer executing such computer program instructions. The computer system may be a multiprocessor computer system or may include multiple computers connected over a computer network. The components shown in FIG. 1 may be separate modules of a computer program, or may be separate computer programs, which may be operable on separate computers. The data produced by these components may be stored in a memory system or transmitted between computer systems.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, a cathode ray tube display, liquid crystal displays and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services.

A memory system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program. The invention is not limited to a particular memory system.

Having now described a few embodiments, it should be apparent to those skilled in the art that the foregoing is merely illustrative and not limiting, having been presented by way of example only. Numerous modifications and other embodiments are within the scope of the invention.

1. A method for performing color correction on an image, comprising, for each pixel to be corrected:
storing an input luminance value corresponding to a luminance of the pixel before color correction;
performing a color correction operation on the pixel to provide color corrected components for the pixel;
determining an output luminance and output saturation corresponding to the color corrected components for the pixel;
determining a scaling factor according to a ratio of the input luminance to the output luminance;
scaling the output saturation by the scaling factor to provide a corrected saturation; and
using the input luminance and the corrected saturation to provide values for the corrected pixel.

2. The method of claim 1, wherein the color correction operation on the pixel is a color matching operation whereby the pixel is modified to match at least a hue of a target color.

3. The method of claim 1, wherein the corrected pixel is represented by a luminance component and chroma difference components, and wherein scaling comprises scaling the chroma difference components of the corrected pixel.

4. A computer program product, comprising:
a computer readable medium;
computer program instructions stored on the computer readable medium that, when processed by a computer, instruct the computer to perform a method for performing color correction on an image, comprising, for each pixel to be corrected:
storing an input luminance value corresponding to a luminance of the pixel before color correction;
performing a color correction operation on the pixel to provide color corrected components for the pixel;
determining an output luminance and output saturation corresponding to the color corrected components for the pixel;
determining a scaling factor according to a ratio of the input luminance to the output luminance;
scaling the output saturation by the scaling factor to provide a corrected saturation; and
using the input luminance and the corrected saturation to provide values for the corrected pixel.

5. The method of claim 4, wherein the color correction operation on the pixel is a color matching operation whereby the pixel is modified to match at least a hue of a target color.

6. The method of claim 4, wherein the corrected pixel is represented by a luminance component and chroma difference components, and wherein scaling comprises scaling the chroma difference components of the corrected pixel.
